(19) United States
(12) Patent Application Publication
(10) Pub. No.: US 2014/0177206 A1
(43) Pub. Date: Jun. 26, 2014

(54) LIGHT EMITTING DIODE LIGHT BAR FOR USE IN A BACKLIGHT MODULE

(71) Applicant: HON HAI PRECISION INDUSTRY CO., LTD., New Taipei (TW)

(72) Inventor: Yi-Zhong SHEU, New Taipei (TW)

(73) Assignee: HON HAI PRECISION INDUSTRY CO., LTD., New Taipei (TW)

(21) Appl. No.: 13/873,144

(22) Filed: Apr. 29, 2013

(30) Foreign Application Priority Data
Dec. 24, 2012 (TW) 101149429

(51) Int. Cl. F21V 23/00

(52) U.S. Cl. CPC F21V 23/005
USPC 362/97.1

(57) ABSTRACT

An LED (light emitting diode) light bar is for use as a light source of a backlight module of an LCD (liquid crystal display). The LED light bar includes a printed circuit board having a circuit therein, a plurality of LED chips located on the printed circuit board and an encapsulation layer sealing the plurality of LED chips. The printed circuit board includes a top surface and a bottom surface opposite to the top surface. The plurality of LED chips are electrically connected to the circuit of the printed circuit board. A middle of the top surface of the printed circuit board is depressed inwardly to define a groove, and the plurality of LED chips are received in the groove.

### BACKGROUND

1. Technical Field

The present disclosure relates generally to light emitting diode (LED) light bars, and more particularly to a light emitting diode light bar with low cost, wherein the LED light bar is used as a light source of a backlight module.

2. Description of Related Art

LEDs (light emitting diode) have been widely promoted as light sources of electronic devices owing to many advantages, such as high luminosity, low operational voltage and low power consumption. LEDs of an LED backlight module of an LCD (liquid crystal display), are usually packaged first, and then be covered with optical lens before being installed into a light bar as a light source for the backlight module, whereby the cost of the LED light bar is high.

Therefore, an LED light bar capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of an LED light bar in accordance with an embodiment of the present disclosure.

FIG. 2 shows a schematic view of the LED light bar of FIG. 1, wherein an encapsulation layer is removed for clarity.

FIG. 3 shows is a cross section of the LED light bar of FIG. 1, taken along line III-III thereof.

### DETAILED DESCRIPTION

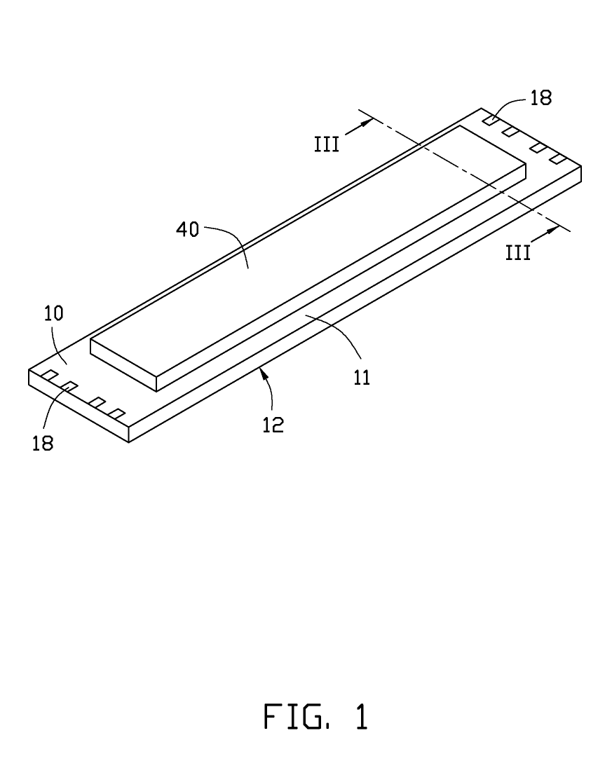

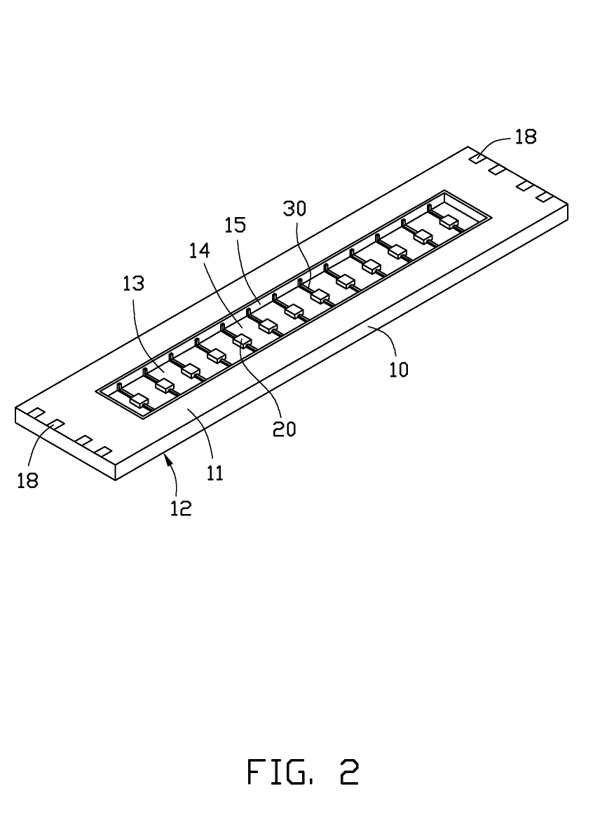

Referring to FIG. 1 and FIG. 2, an LED light bar 1 in accordance with an embodiment of the present disclosure includes a printed circuit board 10, a plurality of LED chips 20 mounted on the printed circuit board 10 and an encapsulation layer 40 sealing the plurality of LED chips 20. The LED light bar 1 is used as a light source for a backlight module, which includes at least a light guide (not shown) and the LED light bar 1 which emits light to the light guide.

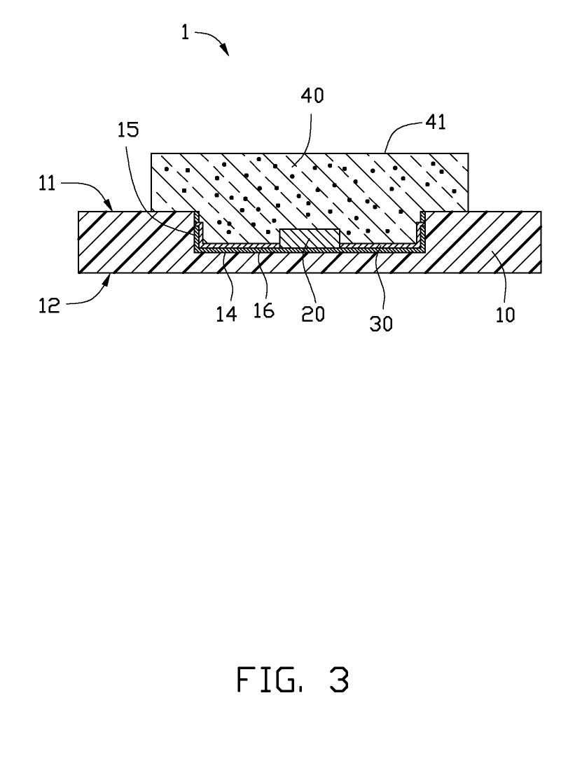

The printed circuit board 10 includes a top surface 11 and a bottom surface 12 opposite to the top surface 11. A middle of the top surface 11 of the printed circuit board 10 is depressed inwardly to define an elongated groove 13. The groove 13 is surrounded by a lower surface 14 and a lateral surface 15 extending from an edge of the lower surface 14 perpendicularly and upwardly to connect with the top surface 11. Referring to FIG. 3, a reflecting layer 16 is formed on the lower surface 14 and the lateral surface 15. The printed circuit board 10 has a circuit therein. The circuit includes at least a plurality of golden fingers 18 at opposite ends of the printed circuit board 10.

The plurality of LED chips 20 are received in the groove 13 of the printed circuit board 10, and located on the lower surface 14. Each of the LED chips 20 is electrically connected with the circuit in the printed circuit board 10 by two wires 30, so the printed circuit board 10 can supply an electrical power to the LED chips 20 when an external power source is connected with and supplies the electrical power to the printed circuit board 10. In this embodiment, the two wires 30 extend from two opposite sides of each of the LED chips 20 to the lateral surface 15 of the printed circuit board 10 along the lower surface 14, and are finally connected to the circuit inside of the printed circuit board 10 along the lateral surface 15.

The encapsulation layer 40 covers and seals the LED chips 20, and fills the whole groove 13, whereby the encapsulation layer 40 protects the LED chips 20. The encapsulation layer 40 includes a top surface 41, and the top surface 41 is a flat surface or curved surface. In this embodiment, a cross section of the encapsulation layer 40 is T-shaped, and a top surface of the encapsulation layer 40 is higher than the top surface 11 of the printed circuit board 10. The encapsulation layer 40 is injected into the groove 13 by a glue dispensing process. The encapsulation layer 40 is then pressed by a mold (not shown) until the required shape of a top end of the encapsulation layer 40 above the top surface 11 and in accordance with the present disclosure is obtained, wherein the encapsulation layer 40 completely fills the groove 13. In addition, fluorescent powder (not shown) can be pre-mixed in the encapsulation layer 40, whereby light emitted from LED light bar 1 can obtain a desired color, when the desired color is different from the color of light directly emitted from the LED chips 20.

In use of the LED light bar 1, light emitted from the LED chips 20 is transmitted to an interior of the encapsulation layer 40. One part of the light travels towards the right above of the LED chips 20, and the other part of the light travels towards the lateral side of the LED chips 20. The light which travels towards the right above of the LED chips 20 is refracted to air when it travels out of the encapsulation layer 40. The light which travels toward the lateral side of the LED chips 20 is incident on the reflecting layer 16 on the lateral surface 15 and the lower surface 14 of the groove 13, and the light is reflected by the reflecting layer 16 to travel through the encapsulation layer 40 above of the LED chips 20. Finally the light leaves the LED light bar 1 to illuminate the light guide. The reflecting layer 16 avoids part of the light emitted from the LED chips 20 from being absorbed by the lateral surface 15 and the lower surface 14 of the printed circuit board 10 and helps the light to have a multidirectional radiation. Furthermore, the light generated by the LED chips 20 can be evenly output from the LED light bar 1 by the use of the reflecting layer 16 and the encapsulation layer 40, without the necessity of the use of a secondary optical lens. Accordingly, the LED light bar 1 can have a lower cost.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An LED (light emitting diode) light bar configured for use as a light source of a backlight module, comprising:
a printed circuit board having a circuit therein, the printed circuit board comprising a top surface and a bottom surface opposite to the top surface;
a plurality of LED chips located on the printed circuit board and electrically connected to the circuit of the printed circuit board; and
an encapsulation layer sealing the plurality of LED chips;
wherein a middle of the top surface of the printed circuit board is depressed inwardly to define a groove, and the plurality of LED chips are received in the groove.

2. The LED light bar of claim 1, wherein the groove is defined by a lower surface and a lateral surface extending upwardly from an edge of the lower surface to the top surface of the printed circuit board, and the plurality of LED chips are located on the lower surface.

3. The LED light bar of claim 2, wherein each of the LED chips is electrically connected to the printed circuit board via two wires, the two wires extends from two opposite sides of the LED chips to the lateral surface of the printed circuit board along the lower surface, and are finally connected to the circuit inside of the printed circuit board.

4. The LED light bar of claim 2, wherein a reflecting layer is formed on the lower surface and the lateral surface.

5. The LED light bar of claim 1, wherein each of the LED chips is electrically connected to the printed circuit board via two wires.

6. The LED light bar of claim 1, wherein the encapsulation fills an entirety of the groove.

7. The LED light bar of claim 6, wherein the top surface of the encapsulation layer is a flat surface or a curved surface.

8. The LED light bar of claim 7, wherein the top surface of the encapsulation layer is a flat surface, and a cross section of the encapsulation layer is T-shaped.

9. The LED light bar of claim 1, wherein the encapsulation layer is mixed with fluorescent powder therein.

10. The LED light bar of claim 1, wherein the circuit of the printed circuit board includes golden fingers at opposite ends of the printed circuit board.
